(19) United States
(12) Patent Application Publication
(10) Pub. No.: US 2008/0036767 A1
(43) Pub. Date: Feb. 14, 2008

(54) Apparatus and method for selecting visualizations of multidimensional data

(75) Inventor: Douglas Stuart Janzen, Vancouver (CA)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/503,486

(22) Filed: Aug. 10, 2006

(51) Int. Cl. G06T 11/20

(52) U.S. Cl. 345/440

(57) ABSTRACT

A computer readable medium includes executable instructions to associate data from a data source with one or more axes of a first visualization. A set of rules are applied to determine if it is meaningful to render the data in a second visualization.

### CROSS REFERENCE TO RELATED APPLICATIONS

This application is related to the following pending, commonly owned U.S. patent application entitled “Apparatus And Method For Visualizing Data”, Ser. No. 11/478,836, Attorney Docket No. BOBJ 102/00US, filed Jun. 30, 2006, which is incorporated herein by reference.

### BRIEF DESCRIPTION OF THE INVENTION

This invention relates generally to digital data processing. More particularly, this invention relates to techniques for recommending possible visualizations of multidimensional data.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information, content delivery infrastructure systems for delivery and management of reports and analytics, data warehousing systems for cleansing and consolidating information from disparate sources, and data management systems, such as relational databases or On Line Analytic Processing (OLAP) systems used to collect, store, and manage raw data.

OLAP tools are a subset of business intelligence tools. There are a number of commercially available OLAP tools including Business Objects OLAP Intelligence™ which is available from Business Objects Americas of San Jose, Calif. An OLAP tools is a report generation tool that is configured for ad hoc analyses. OLAP generally refers to a technique of providing fast analysis of shared multidimensional information stored in a database. OLAP systems provide a multidimensional conceptual view of data, including full support for hierarchies and multiple hierarchies. This framework is used because it is a logical way to analyze businesses and organizations. In some OLAP tools the data is arranged in a schema which simulates a multidimensional schema. The multidimensional schema means redundant information is stored, but it allows for users to initiate queries without the need to know how the data is organized.

There are other report generation tools, including tools that couple to a metadata layer that overlies a data source. The metadata layer can be a semantic metadata layer, or semantic layer, which includes metadata about the type of data within the data source. Some metadata layers map the data source fields into familiar terms, such as, product, customer, or revenue. The metadata layer can provide a multidimensional view of information in a data source. There are a number of commercially available report generation tools that are characterized by a semantic layer, including Business Objects Web Intelligence™, which is available from Business Objects Americas of San Jose, Calif.

There are known techniques for graphically portraying quantitative information. The techniques are used in the fields of statistical graphics, data visualization, and the like. Charts, tables, and maps are visualizations of quantitative information. Visualizations are produced from data in a data source (e.g., an OLAP cube, relational database). Visualizations can reveal insights into the relationships between data. In tables, where data is displayed in columns and rows, such insights can be inefficient, difficult, or even impossible to obtain. While tables are limited in variety, there are many types of charts and maps.

Existing BI tools have limitations with regards to visualizations. One limitation is that most users chose to display information in tabular form. This limitation is demonstrated by the frequency of the use of tables compared to the other visualizations in representative samples of reports generated from the BI tools. It is not known exactly why users avoid using the diversity of maps and charts provided by BI tools. It is believed that users find that the mechanics of associating data with axes, defining the relevant parameters, and completing other visualization creation tasks is difficult.

In view of the foregoing, it would be highly desirable to provide an improved technique for generating visualizations of data.

### SUMMARY OF INVENTION

The invention also includes a computer readable medium with executable instructions to associate data from a data source with one or more axes of a first visualization. A set of rules are applied to determine if it is meaningful to render the data in a second visualization.

The invention also includes a computer readable medium with executable instructions to map a first portion of data from a first multidimensional data source to a first axis in a first visualization. Executable instructions then determine if it is meaningful to render the data in a second visualization.

The invention also includes a computer readable medium with executable instructions to specify a set of rules to assess whether a visualization is applicable to a view of data in a business intelligence tool. The data from the view of data in the visualization is rendered. A list of visualizations that the business intelligence tool can render is updated.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates a series of processing operations associated with an embodiment of the invention.

FIG. 3 illustrates a graphical user interface configured in accordance with an embodiment of the invention.

FIG. 4 illustrates the graphical user interface of FIG. 3 with a dimension mapped to the x-axis of a visualization in accordance with an embodiment of the invention.

FIG. 5 illustrates the graphical user interface of FIG. 4 with a measure mapped to the y-axis of the visualization yielding a bar chart in accordance with an embodiment of the invention.

FIG. 6 illustrates the graphical user interface of FIG. 5 with a plurality of measure mapped to the z-axis of the visualization yielding a bar chart with a series of bars in accordance with an embodiment of the invention.

FIG. 7 illustrates the graphical user interface of FIG. 6 where a user has selected a series of pie charts to be rendered in place of the series of bars in accordance with an embodiment of the invention.

FIG. 8 illustrates the graphical user interface of FIG. 3 with one measure mapped to each of the x-axis and the y-axis.

FIG. 9 illustrates the graphical user interface of FIG. 8 with a dimension mapped to each of the z-axis and a scatter plot rendered in accordance with an embodiment of the invention.

Like reference numerals refer to corresponding parts throughout the several views of the drawings.

### DETAILED DESCRIPTION OF THE INVENTION

Various features associated with the operation of the present invention will now be set forth. Prior to such description, a glossary of terms used throughout this description is provided.

Axis. An axis is a space along which data is arranged. For example, an axis is a line or curve in a visualization that defines a spatial direction within the visualization. An axis can be a line with equal values. A pair of orthogonal axes, e.g., an x-axis and a y-axis, defines a Cartesian coordinate system.

Chart. A chart includes a collection of visual elements used to convey information. A chart is a visualization.

Data. Data is qualitative or quantitative information that is stored in a data source. Data is the information that is presented in a report. Data can have associated metadata.

Dimension. A dimension is a line in a real or abstract space. An example of a real space dimension is a pair of antiparallel cardinal points on a compass, e.g., North and South, North-northwest and South-southeast. Another real dimension is time. An example of an abstract space dimension is a list of stores. The dimension is abstract because the list can be ordered alphabetically by name, by store number, by distance from head office, etc. Examples of dimensions include region, store, year, customer, employee, product line, and the like.

Family. A family is a group of similar or related things. Visualizations can be grouped into families. Charts can be grouped into families. Families of charts include, but are not limited to: status charts (e.g., gauges, barometers/thermometers, LEDs); variation charts (e.g., radar, polar, heat maps); contribution comparison charts (e.g., pie, stacked 100%, pie series); rank compare charts (e.g., horizontal, grouped bar, deviation/zero axis bar, floating, stacked/subdivided); time series charts (e.g., line graph, column, waterfall/floating, deviated/zero axis, stacked/subdivided bar, stock/open-high-low-close, times series line, times series surface); frequency distribution charts (e.g., histogram, histograph); correlation charts (e.g., scatter plot, bubble plot, paired bar chart, paired/multiple scatter plot, bubble chart); combination charts (e.g., bar chart with line, pie slice with stacked bar, pie in time series, table); and other charts (e.g., graphical lists, spie chart, chart, log plot, semi-log plot, stereogram, contour plot, hanging rootogram, box plot, bag plot, mesh plot, contour plot, graph, network, and tree).

Measure. A measure is a quantity as ascertained by comparison with a standard, usually denoted in some unit, e.g., units sold, dollars. A measure, such as revenue, can be displayed for the dimension “Year”. Corresponding measures can also be displayed for each of the values within a dimension.

Region of focus. The region of focus is an area of the report which the user wishes to explore. The region of focus is either set by default or is definable by a user event.

User event. A user event is an action taken by the operator of a computer. User events include the user clicking on an area of a table, chart, map or portion thereof which displays quantitative information. The user can select one or more: charts, maps, columns or rows in a table, axes or data within a chart, data in a time series, or regions in a map. Alternatively, the user event can include the user specifying a parameter to a report document.

Metadata. Metadata is information about information. Metadata can constitute a subset or representative values of a larger data set. For example, a piece of metadata could be associated with a piece of data and provide a description to that piece of data.

Table. A table maps the logical structure of a set of data into a series of columns or rows. Thus, a table is a visualization. To facilitate representation in two dimensions, higher-dimensional tables of data are often represented in an exploded view comprising a plurality of two dimensional tables. A table can be rectangular, triangular, octagonal, etc. A table can have row and column headings, where each cell in a table can show the value associated with the specific combination of row and column headings. Some tables can hold charts or maps in their cells; this is a spatially economic way to display many charts with common axes. A table is to be conceptually differentiated from a database table.

Value. A dimension includes one or more values, each of which can have associated measures. For example, the “Year” dimension may include 1999, 2000, 2001, 2002 as its values. The “Quarter” dimension would normally have 4 values corresponding to each quarter. Values can be displayed with associated measures.

Visualization. A visualization is a graphic display of quantitative information. Types of visualizations include charts, tables, and maps.

Cross-tab. A cross-tab (abbreviation of cross-tabulation) is a visualization of data that displays the joint distribution of two or more variables simultaneously. Cross-tabs are usually presented in a matrix format. Each cell shows the value associated with the specific combination of row and column headings.

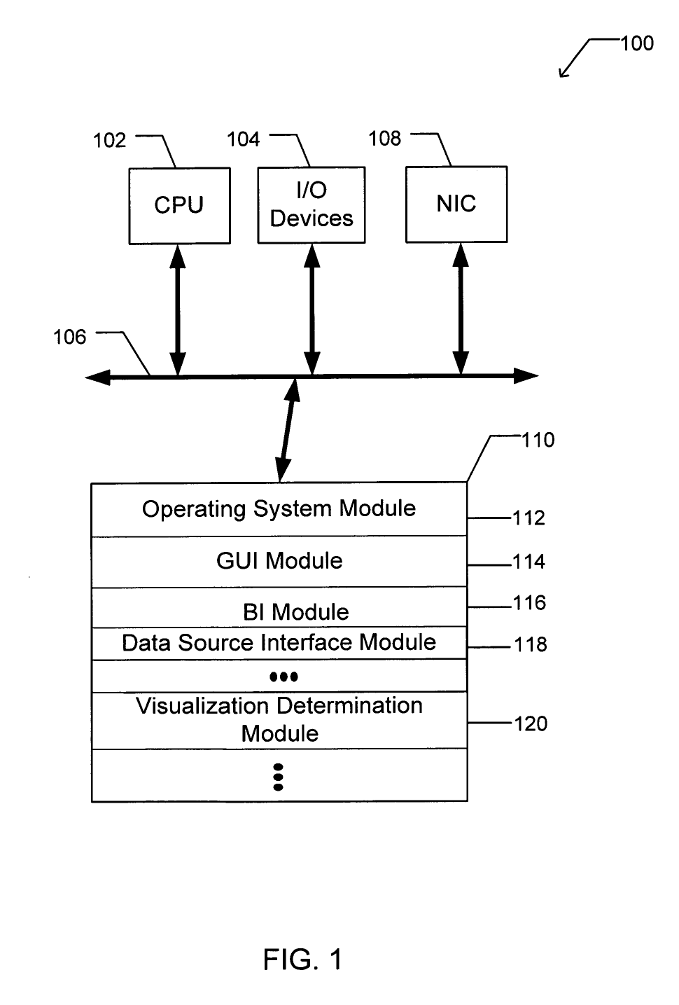

FIG. 1 illustrates a computer 100 configured in accordance with an embodiment of the invention. The computer 100 includes standard components, including a central processing unit 102 and input/output devices 104, which are linked by a bus 106. The input/output devices 104 may include a keyboard, mouse, touch screen, monitor, printer, and the like. A network interface circuit 108 is also connected to the bus 106. The network interface circuit (NIC) 108 provides connectivity to a network (not shown), thereby allowing the computer 100 to operate in a networked environment.

A memory 110 is also connected to the bus 106. In an embodiment, the memory 110 stores one or more of the following modules: an operating system module 112, a graphical user interface (GUI) module 114, a business intelligence (BI) module 116, a data source interface module 118, and a visualization determination module 120.

The operating system module 112 may include instructions for handling various system services, such as file services or for performing hardware dependant tasks. The GUI module 114 may rely upon standard techniques to produce graphical components of a user interface, e.g., windows, icons, buttons, menu and the like, examples of which are discussed below.

The BI module 116 includes executable instructions to perform BI related functions, such as, generate reports, perform queries and analyses, and the like. The BI module 116 can include a data source interface module 118, as a sub-module. The data source interface module 118 includes executable instructions for interfacing with an OLAP data source, such as, an OLAP cube or semantic layer. The data source interface module 118 can include executable instructions to allow computer 100 to link any OLAP data source, such as via an application program interface, to specific types, versions, or formats of a data source.

The visualization determination module 120 includes executable instructions to automatically determine if a visualization could be created based on specified data. The module 120 includes rules to determine whether a given chart type can render a meaningful representation for the data. The visualization determination module 120 can be interrogated by the BI module 116 or the data source interface module 118.

The executable modules stored in memory 110 are exemplary. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

A user interacts with a BI tool in the BI module 116. In an embodiment, the user maps data from a data source, e.g., an OLAP cube to an axis of a visualization in a GUI. The visualization determination module 120 provides feedback to the BI tool and the user as to which visualizations can be rendered from the data.

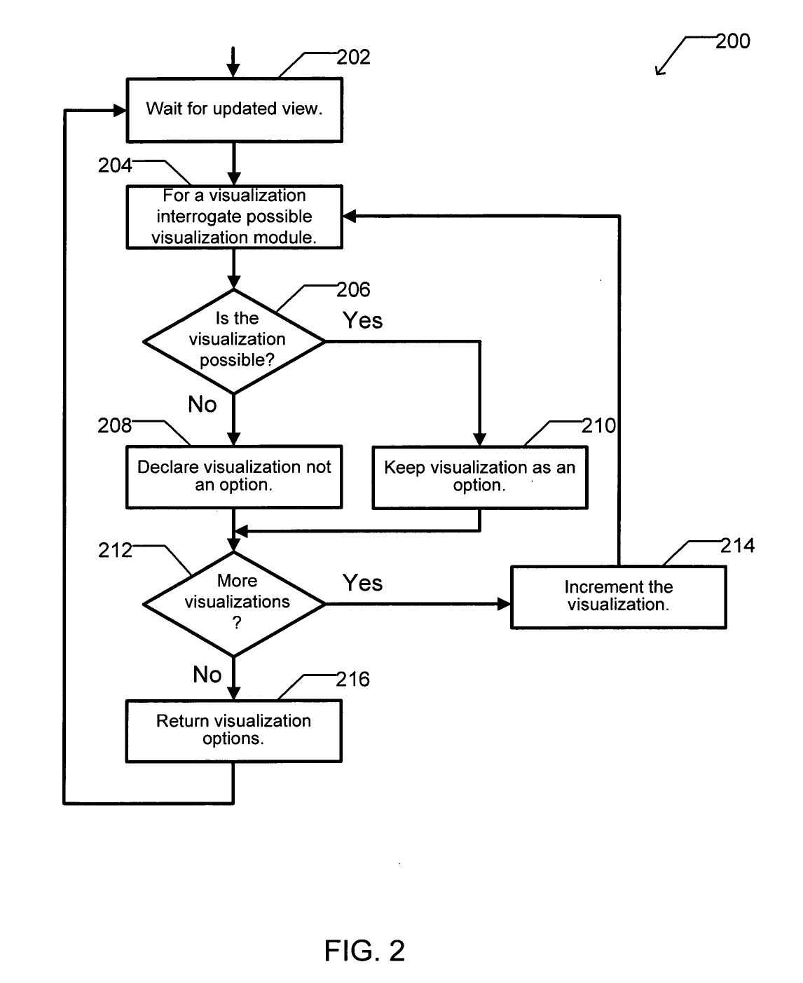

FIG. 2 illustrates a set of processing operations 200 that computer 100 implements while executing instructions from the BI module 116 or data source interface module 118 and the visualization determination module 120. The processing operations 200 determine the visualizations that an application can render which are meaningful for the present data. The application (e.g., BI tool or OLAP tool stored in module 116) waits for and receives an update of the view of a data source 202. The updated view includes a new view, a new data source and/or refreshed data from an old data source. In an embodiment, the updated view is an application mapping of a portion of data of an axis in a visualization. In an embodiment, the updated view is effected by a user input. The input is a mapping or association of a portion of data from a data source to an axis in a visualization. In an embodiment, the visualization is a chart. In another embodiment, the visualization is a table, e.g., a cross tab. In an embodiment, the portion of data is mapped to an axis of a yet to be determined visualization.

For each visualization that the application is capable of rendering, the application queries the possible visualization module to determine if the visualization makes sense for the given data. The application selects a visualization and submits it to the visualization determination module 120, 204. Instructions in the visualization determination module 120 determine if the visualization makes sense for the given data 206. If the visualization is inappropriate (206-No), this fact is reported to the user or application 208. Typically, the application will not use the visualization. If the visualization is possible (206-Yes), then the given visualization is flagged by the application as meaningful 210. In an embodiment, the visualization determination module 120 uses metadata associated with the given data to determine if the visualization makes sense.

The application then determines if there are more visualizations 212. If so (212-Yes), then the current visualization is incremented 214. If not (212-No), then the processing continues at operation 216. In an embodiment, in operation 216 the visualization options are presented to the user. In another embodiment, the visualization options are updated view of a data source.

The following code segment is pseudo code that invokes some of the processing operations of FIG. 2. This pseudo code corresponds to code that may be utilized in the BI module 116 or a data source interface module 118 of FIG. 1.

Pseudo Code Segment A: Invocation Code

AA ...
AB View view = scenario.getView( );
AC DataObjectList allVisualizations = scenario.getAllVisualizations
AD for (Iterator iter = allVisualizations.iterator( ); iter.hasNext( );) {
AE VisualizationsInterface visualization = iter.next( )
AF boolean canRender = visualization.canRender(view);
AG if (canRender)
AH visulizationCommandList.Add(visualization);
AI }
AJ ...

In this segment, the pseudo code at line AB declares a view and equates it with the view of the current scenario of the application. A view is a data structure that contains details about the data source, e.g., OLAP data source or semantic layer and how the data is mapped to the axes of a visualization. At line AC, a data structure is created with all the visualizations the application can render. At lines AD through AI, each of these visualization is tested against a canRender function. In an embodiment, the canRedner function is stored in visualization determination module 120. If the visualization can be rendered (line AG), the visualization is added to a list of commands that the application can execute (line AH). The for loop in lines AD through AI correspond to implementation processing operations 204 through 214 of the set of processing operations 200 of FIG. 2.

The following code segment is pseudo code for the canRender function invoked in Pseudo Code Segment A. Code Segment B is for bar charts.

Pseudo Code Segment B: canRender Bar Chart

| | |
|---|---|
| BA | ... |
| BB | public boolean canRender(View view) { |
| BC | boolean xAxisContainsMeasures = view.getXAxis( ).- |
| | containsMeasures( ); |
| BD | boolean yAxisContainsMeasures = view.getYAxis( ).- |
| | containsMeasures( ); |
| BE | return xAxisContainsMeasures \hat{ } yAxisContainsMeasures; |
| BF | } |
| BG | ... |

In this segment, the canRender function takes a view and determines if a bar chart would be a meaningful visualization for the data. In lines BC and BD each axis is checked to see if it contains a measure. The logical exclusive-OR of the result of these checks is returned to the invoking code. In an embodiment, the invoking code is similar to Pseudo Code Segment A. The logic in the Pseudo Code Segment B indicates that a bar chart can be meaningful if either the x-axis or the y-axis contains a measure, but not both. Hence, a bitwise exclusive-OR or XOR (“̂”) is used at line BE.

The following code segment is pseudo code for the canRender function invoked in Pseudo Code Segment A for pie charts.

Pseudo Code Segment C: canRender Pie Chart

| | |
|---|---|
| CA | ... |
| CB | public boolean canRender(View view) { |
| CC | boolean xAxisContainsMeasures = view.getXAxis( ).- |
| | containsMeasures( ); |
| CD | boolean yAxisContainsMeasures = view.getYAxis( ).- |
| | containsMeasures( ); |
| CE | int zAxisSize = view.getZAxis( ).getAxisDimensions( ).size( ); |
| CF | return xAxisContainsMeasures \hat{ } yAxisContainsMeasures |
| | && zAxisSize > 0; |
| CG | } |
| CH | ... |

In this segment, the canRender function takes a view and determines if a pie chart is a meaningful visualization for the data. Pseudo Code Segments B, C, D and E all contain the same function name “canRender”, but with different interfaces, such that the executable instructions in memory 110 can be easy expanded. In lines CC and CD, each axis is checked to see if it contains a measure. At line CE, the size of the axis is determined. The exclusive-OR of the results of the first two checks is applied to a logical AND operation with a check that the axis has greater than zero size and is returned to the invoking code (line CF). The logic in the Pseudo Code Segment C indicates that a pie chart can be meaningful if either the x-axis or the y-axis contain a measure, but not both, and the z-axis must contain at least one dimension.

The following pseudo code segment is for scatter charts. The segment is pseudo code under the canRender function interface invoked in Pseudo Code Segment A.

Pseudo Code Segment D: canRender Scatter Chart

| | |
|---|---|
| DA | ... |
| DB | public boolean canRender(View view) { |
| DC | boolean xAxisContainsMeasures = view.getXAxis( ).- |
| | containsMeasures( ); |
| DD | boolean yAxisContainsMeasures = view.getYAxis( ).- |
| | containsMeasures( ); |
| DE | return xAxisContainsMeasures && yAxisContainsMeasures; |
| DF | } |
| DG | ... |

In this segment, the canRender function takes a view and determines if a scatter chart is a meaningful visualization for the data. In lines DC and DD, each axis is checked to see if it contains a measure. These checks are applied to a logical AND operation and the result is returned to the invoking code. The logic in the Pseudo Code Segment D indicates that a scatter chart can be meaningful if either the x-axis and the y-axis contain a measure. The scatter chart cannot be rendered in the absence of a dimension in the z-axis. However, it is possible to have a scatter chart with a measure in each axis.

The following pseudo code segment is for displaying data. The segment is pseudo code under the canRender function interface invoked in Pseudo Code Segment A.

Pseudo Code Segment E: canRender Display Data

EA ...
EB public boolean canRender(View view) {
EC return true;
EF }
EG ...

In this segment, the canRender function takes a view and determines if raw data can be displayed. Since data can always be displayed, true is returned to the invoking code at line EC.

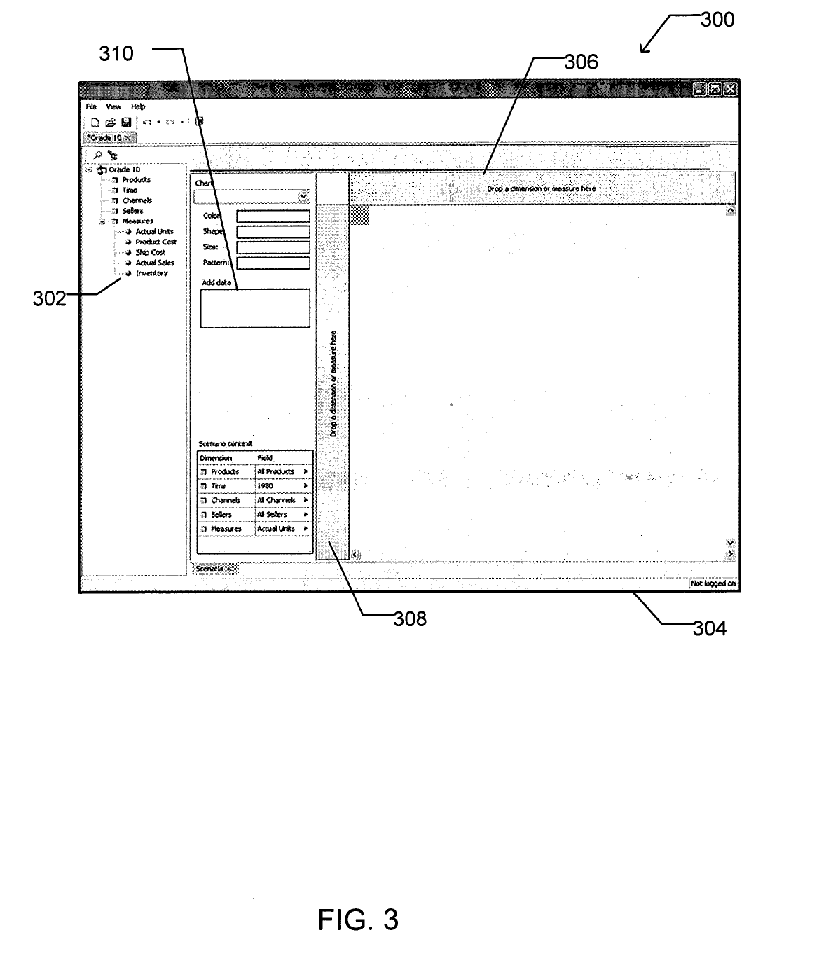

FIG. 3 illustrates a graphical user interface 300 configured in accordance with an embodiment of the invention. The GUI 300 could be included in a window presented on an output device of computer 100. In an embodiment, the GUI 300 is part of a BI tool. The GUI 300 includes a data source region 302. Data can be mapped from this region to other parts of the GUI 300. Here data source region 302 depicts the connection to an OLAP cube. In an embodiment, the data source region depicts a semantic layer overlying a data source. In one embodiment, the data source region depicts both a semantic layer and an OLAP cube. The GUI 300 includes generic visualization 304. The generic visualization 304 includes an x-axis 306 and a y-axis 308. A z-axis 310 is included in GUI 300. Data from the data source region can be mapped to the x-axis 306, y-axis 308 and z-axis 310.

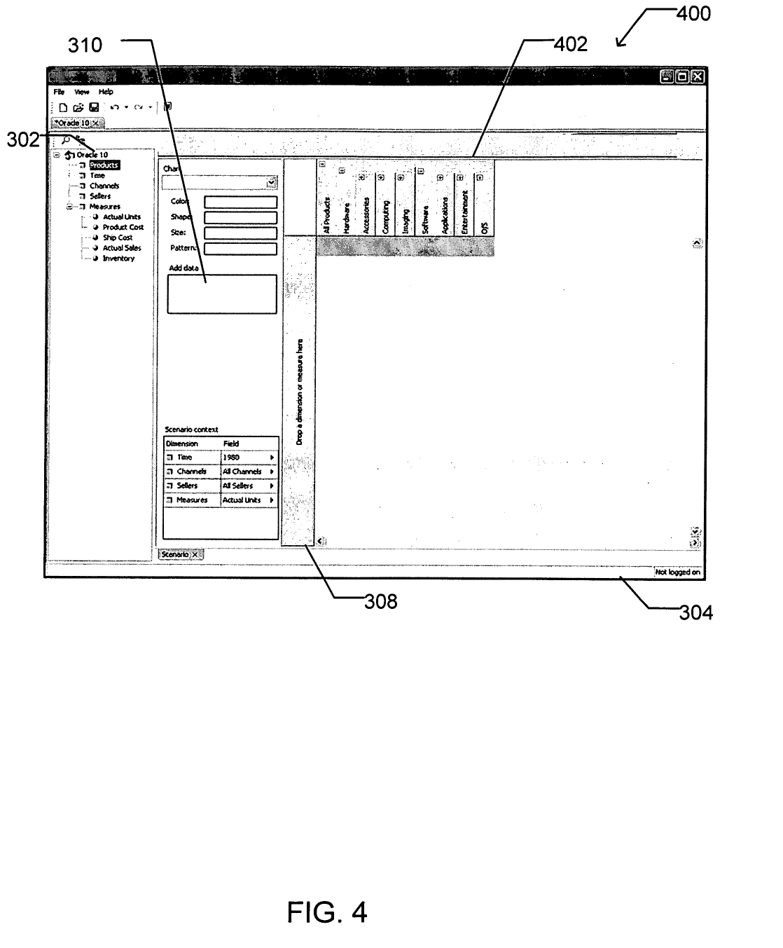

FIG. 4 illustrates a graphical user interface 400 configured in accordance with an embodiment of the invention. The GUI 400 shows the GUI 300 with a dimension mapped from the data source region to the x-axis 402. The dimension is “Product”.

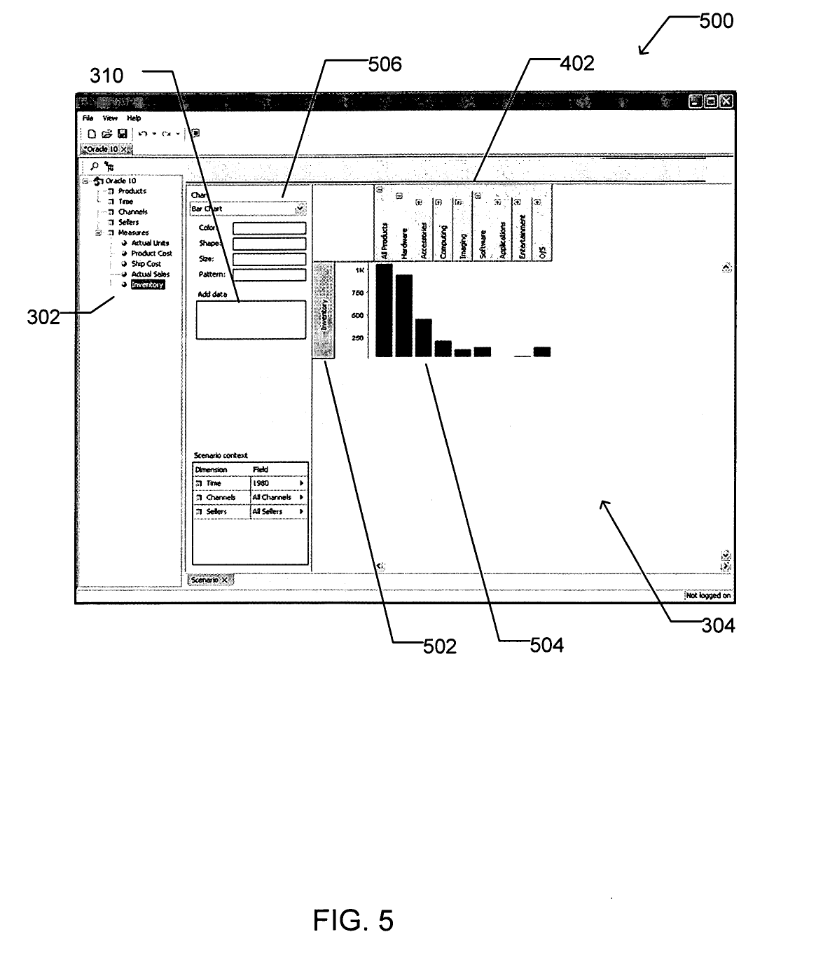

FIG. 5 illustrates a graphical user interface 500 configured in accordance with an embodiment of the invention. The GUI 500 shows the GUI 400 with a measure mapped to the y-axis 502. The measure shown in FIG. 5 is “Inventory”. Because one of the x-axis and the y-axis, but not both, contains a measure, a bar chart 504 is rendered. The user can change the chart type with drop down list 506.

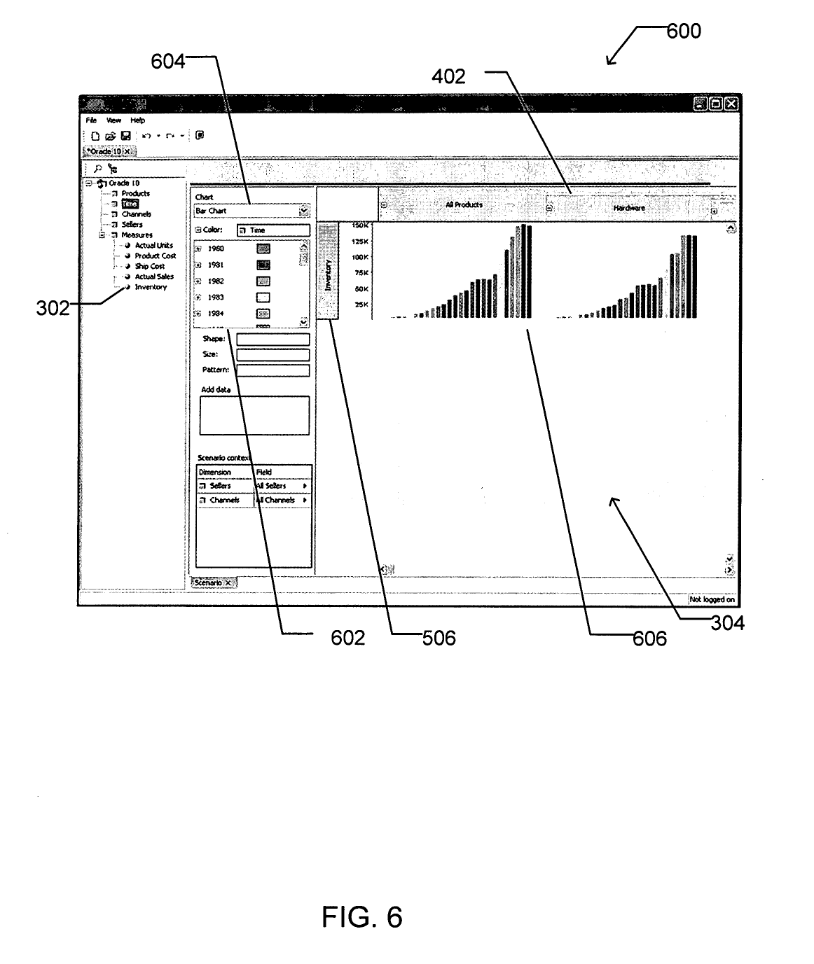

FIG. 6 illustrates a graphical user interface 600 showing the result of a workflow performed with GUI 500. The user has mapped a dimension to the z-axis 602. The dimension shown in FIG. 6 is “Time”. Because one of the x-axis and the y-axis, but not both, contains a measure, and the z-axis contains a dimension, it is meaningful to render a pie chart. The user can select a pie chart via drop down list 604. In an embodiment, because a bar chart was previously rendered, a bar chart 606 remains. However, the bar chart 606 is updated from bar chart 504 to reflect the fact the z-axis includes a dimension.

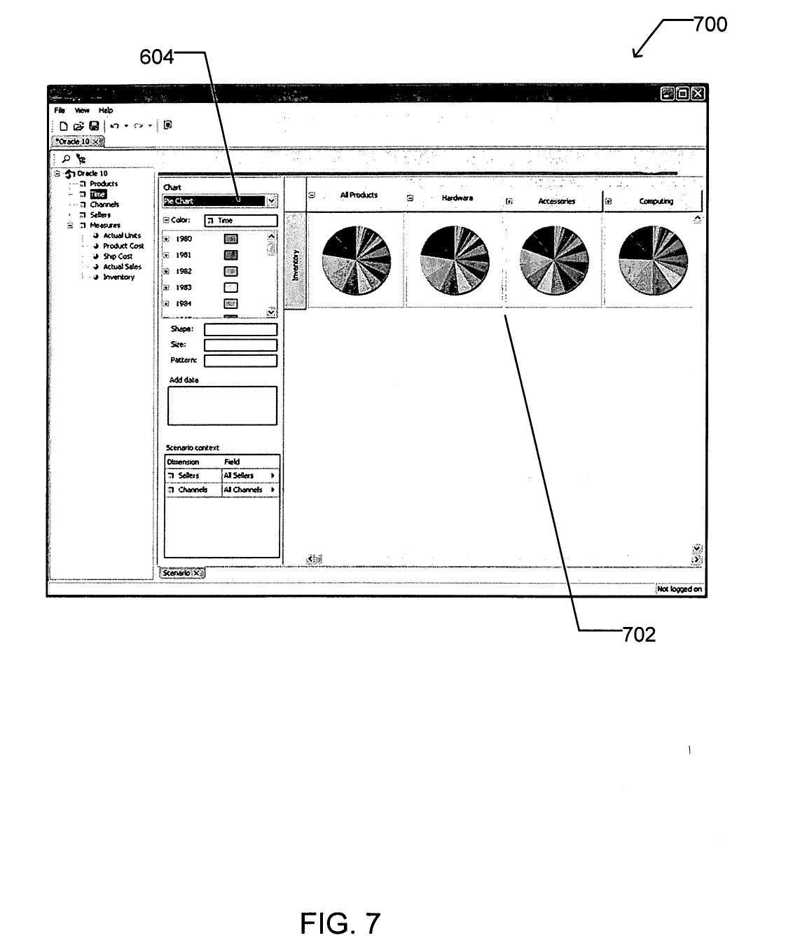

FIG. 7 illustrates a graphical user interface 700 showing the result of a workflow performed with GUI 600. The user has selected pie charts via drop down list 604. A series of pie charts 702 is rendered.

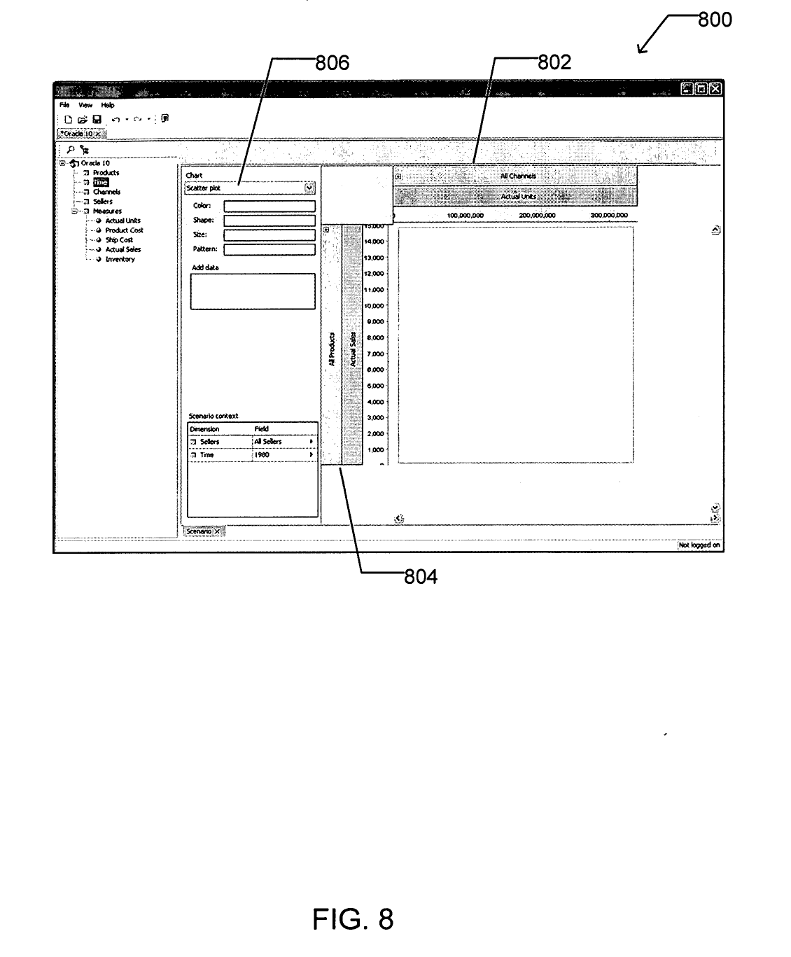

FIG. 8 illustrates a graphical user interface 800, showing the GUI 300 with two measures mapped from the data source region to the x-axis 802 and y-axis 804. The GUI 800 is configured in accordance with an embodiment of the invention. The measure mapped from the data source region to the x-axis 802 is “All Channels”. The measure mapped from the data source region to the y-axis 804 is “All Products”. The user can drill down and roll up these measures as desired. Because the generic visualization includes two measures, one each in the x-axis and y-axis, a scatter chart is meaningful for this mapping of data from the data source to the generic visualization. The chart type “scatter plot” is shown in the drop down list of visualizations 806.

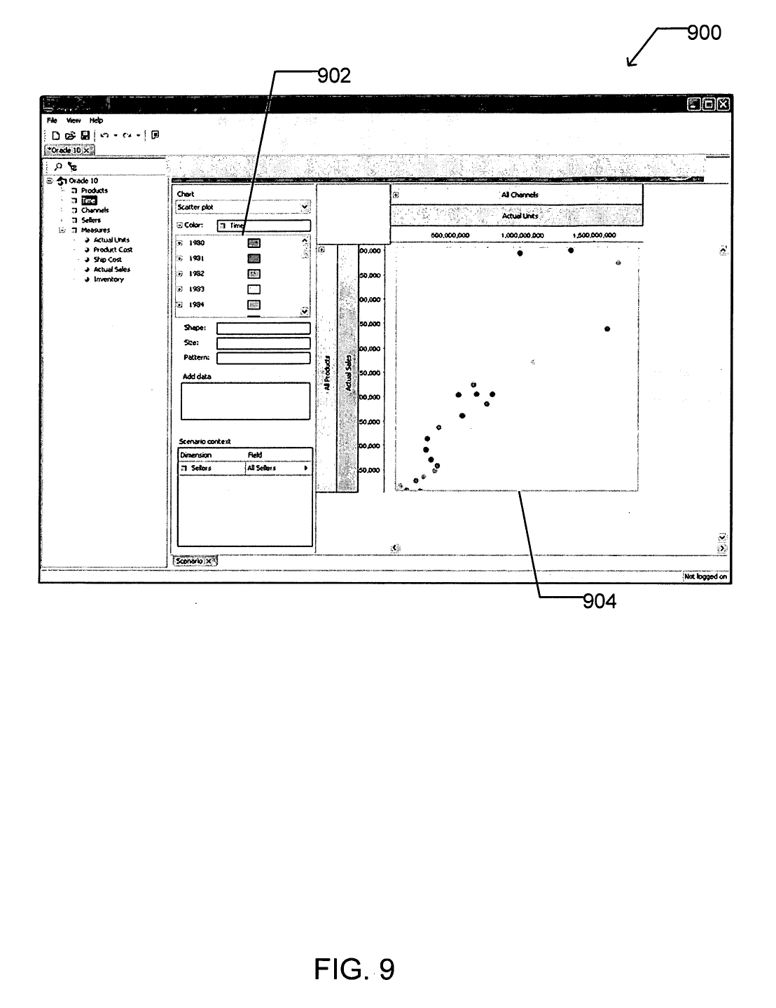

FIG. 9 illustrates a graphical user interface 900 showing the GUI 800 with a dimension mapped from the data source region to the z-axis 902. The GUI 900 is configured in accordance with an embodiment of the invention. The dimension is “Time”. As the generic visualization includes two measures, one each in the x-axis and y-axis, and a dimension on the z-axis, a scatter chart is rendered 904.

The workflow depicted in FIGS. 4 through 9 makes use of the executable instructions in the visualization determination module 120. With each input, e.g., a user interface gesture mapping a portion of data to an axis, and for each visualization the application can render, the application queries the visualization determination module 120. The purpose of the query is to determine if the data mapped to an axis leads to a meaningful visualization.

In an embodiment of the present invention, the list of visualizations for which the view of the data can be checked against is expandable. In an embodiment, to expand the list, executable instructions are loaded into the memory 110 of FIG. 1. The instructions encode a set of rules specifying whether a new visualization is applicable to a given view of data. The view of data could be in a BI tool stored in the BI module 116. The instructions take the data for the view and render it in the visualization. The instructions update the list of visualizations that the business intelligence tool renders.

The aforementioned rules or instructions encoding the rules could be created using the above pseudo code segments as a guide. That is, canRender functions can be created for more visualizations. For example, a stacked bar chart requires multiple measures. Whereas a chart from the status chart family (e.g., a speedometer or thermometer chart) requires a single value per cell (i.e., one measure) and nothing on the z-axis. Many visualization could be added to embodiments of the present invention. These include the following chart families: status charts, variation charts, times series charts, correlation charts, compare contribution charts, combination charts, frequency distribution charts, and rank compare charts.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium, comprising executable instructions to:
associate data from a data source with one or more axes of a first visualization; and
apply a set of rules to determine if it is meaningful to render the data in a second visualization.

2. The computer readable medium of claim 1 further comprising executable instructions to link metadata associated with the data to the set of rules.

3. The computer readable medium of claim 2 wherein the metadata specifies if the data includes dimensions or measures.

4. The computer readable medium of claim 1 wherein the first visualization is a generic visualization including a plurality of axes.

5. The computer readable medium of claim 1 wherein the first visualization and the second visualization are selected from the group comprising a chart, a map, and a table.

6. The computer readable medium of claim 1 further comprising executable instructions to:
reject the second visualization if it is not meaningful to render the data in the second visualization; and
accept the second visualization if it is meaningful to render the data in the second visualization.

7. A computer readable medium, comprising executable instructions to:
map a first portion of data from a first multidimensional data source to a first axis in a first visualization; and
determine if it is meaningful to render the data in a second visualization.

8. The computer readable medium of claim 7 further comprising executable instructions to map a second portion of data to a second axis in a first visualization.

9. The computer readable medium of claim 8 wherein the second portion of data is from a second multidimensional data source.

10. The computer readable medium of claim 9 wherein the first multidimensional data source and the second multidimensional data source are selected from at least one of an On Line Analytic Processing (OLAP) cube and a semantic layer.

11. The computer readable medium of claim 7 further comprising executable instructions to add the second visualization to a list of valid visualizations.

12. The computer readable medium of claim 111 further comprising executable instructions to present the list of valid visualizations to an application running on a computer.

13. The computer readable medium of claim 11 further comprising executable instructions to:
select a third visualization from a list of visualizations; and
determine if it is meaningful to render the data in the third visualization.

14. A computer readable medium, comprising executable instructions to:
specify a set of rules to assess whether a visualization is applicable to a view of data in a business intelligence tool;
render data from the view of data in the visualization; and
update a list of visualizations that the business intelligence tool can render.

15. The method of claim 14 wherein the visualization is selected from the group including at least two of a chart, a map, and a table.

16. The computer readable medium of claim 15 wherein the chart is selected from the group including at least two of: a bar chart, a pie chart, a scatter chart, a status chart, a variation chart, a times series chart, a correlation chart, a compare contribution chart, a combination chart, a frequency distribution chart, and a rank compare chart.
